(19) United States
(12) Patent Application Publication
(10) Pub. No.: US 2016/0364673 A1
(43) Pub. Date: Dec. 15, 2016

(54) METHOD AND SYSTEM FOR AUTOMATED AND INTEGRATED ASSESSMENT RATING AND REPORTING

(71) Applicant: Development Dimensions International, Inc., Bridgeville, PA (US)

(72) Inventors: William C. BYHAM, Pittsburgh, PA (US); Audrey B. SMITH, Pittsburgh, PA (US); Douglas H. REYNOLDS, Pittsburgh, PA (US); Paul R. BERNTHAL, Pittsburgh, PA (US); Ryan HEINL, Smyrna, GA (US); Sudhir THAIKOOTATHIL, McDonald, PA (US); Alexander R. SCHWALL, Pittsburgh, PA (US)

(21) Appl. No.: 14/734,154

(22) Filed: Jun. 9, 2015

(51) Int. Cl. G06Q 10/06; G09B 7/02

(52) U.S. Cl. CPC G06Q 10/06398; G09B 7/02

(57) ABSTRACT

An automated assessment process for rating, integrating, and reporting for assessment centers, based upon research is described, that takes the place of the traditional manual, clinical process, and corrects for potential human biases present using traditional assessment processes. The automated assessment process includes providing an assessment to a participant and receiving behavior ratings for one or more associated behaviors demonstrated by the participant during the assessment. The automated process also includes determining an initial competency rating based upon the behavior ratings. Each initial competency rating is combined with non-simulation assessment results and a final competency rating is determined for each competency being assessed. A report is then automatically generated that includes the final competency rating for each competency being assessed. The report may additionally include a listing of one or more topics for a feedback discussion between the assessment participant and an assessment administrator.

### BACKGROUND

Making good decisions in hiring, promoting, and developing employees is vital to ensuring that an organization can bridge the gap between defining its strategies and executing these strategies. Psychologists and business executives have for decades relied upon results obtained from the assessment center method to help make these important decisions about employees and employment candidates. Over 50 years of research studies and experience support the use of assessment centers, which have been proven to enable employers to better predict success on the job and to decrease individual biases in selection, promotion, and development decisions made by individual hiring managers and internal corporate development managers.

An assessment center is a method for putting participants through simulation exercises (“simulations”) designed to allow the participants (assessees) to demonstrate, under standardized conditions, the skills and behaviors that are important for success in a given job. The simulations might involve realistic situations where the participants have to interact with “peers” or “subordinates,” or a “boss” (with trained assessors playing these roles). For example, a participant may have a conversation with his or her “boss” about the loss of a big client to a competitor. Participants may also have to take various sources of information, such as emails or reports, and make decisions or prepare a formal report for senior management. Unlike a multiple choice written test, where participant responses are theoretical (i.e., what the participant would do), participants in an assessment center actually are put into situations and they have to respond as they would at the office.

The use of a number of job-related simulations may be the sole component of an assessment center. The International Congress on Assessment Center Methods, a 40-year-old industry group of recognized experts from around the world, has published an approved set of consensus guidelines regarding best practices for implementing assessment centers. These guidelines, called the “Guidelines and Ethical Considerations for Assessment Center Operations” (the “International Guidelines”), have been amended and republished five times with the latest version being published in 2015. The International Guidelines have served as a standard for implementing assessment centers in many Federal court cases. The International Guidelines state that the use of simulations is the single most important input into an assessment center and that an assessment center that uses only observations from simulations can stand alone as a measure of target competencies.

When using an assessment center, it is imperative that assessment rating, rating integration, and reporting for individual participants, as well as for groups of similarly situated participants, is reliable, consistent, and valid. The assessment center methodology relies upon simulations that are designed to elicit from participants overt demonstrations of sets of related behaviors, each set constituting a “competency.” A job analysis of the job for which the participant is being considered is used to create the list of competencies that are required for success in the target job and that are aligned with company strategy. Each simulation used in an assessment center is designed to prompt behaviors that are parts of one or more competencies. The assessors are trained to observe the behaviors that make up each target competency. For example, the competency “Leading Change” could be demonstrated by one or more of the following types of behaviors: (i) identifies change opportunities; (ii) stretches boundaries; (iii) catalyzes change; and (iv) removes barriers and resistance. As participants go through an assessment center, their behavior in simulations relative to the target competencies for those simulations is observed by one or more trained assessors, and the competencies demonstrated as a result of the participants' behaviors are rated. In a traditional simulation, the participant does not need to demonstrate all of the possible behaviors in order to obtain a rating for that competency. Assessors make competency rating judgments (typically rated on a 1-5 scale) after observing the demonstrated behaviors in one or more simulations. Typically different assessors observe a participant relative to the participant's behavior in each simulation.

While the International Guidelines state that assessment centers can consist of simulations only, they also provide that assessment centers can, if desired, use other data to evaluate certain target competencies. This data can come from a personality assessment instrument, an experience inventory, a motivational fit inventory, or multi-rater evaluations (where a participant's manager or subordinates or peers evaluate the participant on the target competencies based upon their observations of the participant on the job). These non-simulation assessment instruments provide ratings relative to the subject matters being evaluated. Personality inventories and biographical information provided by the participant, for example, provide descriptive data that may be used to better understand the competency ratings from the simulations.

FIG. 1 illustrates a process flow for an assessment platform according to traditional techniques that include, for example, only simulations. Initially, based on organizational needs, an administrator, manager or other similar supervisor may determine 105 one or more appropriate competency targets. Based upon the determined competencies, the administrator may determine 110 a set of appropriate simulations to be undertaken by the assessment participants. The administrator organizes the simulations into an assessment center and administers 115 the simulations, either via assessment software or via live role-play. The assessors observe the participant's performance 120 as the participants complete the administered simulations.

An assessor is assigned to rate the first simulation for a particular participant. The assigned assessor observes 120 the participant's performance and rates 125 all of the competencies targeted by the first simulation. If additional simulations are available to be rated 130, the cycle repeats and an assessor is assigned to observe 120 and rate 125 the next simulation. Thus, as a group, the simulations could be rated by a mix of assessors, each rating one or more simulations.

Because more than one assessor has observed the participant's performance in the simulations, the assessors must discuss the participant's competency performance across the set of completed simulations. In this discussion, the assessors must determine 135 and agree on a final rating for each competency based upon their collective reported observations made during the simulations. Once final consensus ratings have been created, the assessor providing the feedback to the participant or the participant's manager produces 140 a written report that includes all of the consensus target competency ratings. Based upon the written report, a feedback provider conducts 160 a feedback discussion with the participant or the participant's manager, during which competency ratings are shared and the assessor discusses the meanings of the ratings and possible development needs and opportunities with the participant or the participant's manager.

This traditional method for obtaining simulation competency ratings is clinical and manual and is subject to the individual assessors' judgments regarding each competency observed. In some cases, assessors may draw conclusions based on broad observations about the participant, inferring competency performance where no examples of supporting behaviors were directly observed. Assessor judgment also enters the assessor meeting, where individual personalities, relationships, and biases may enter into the competency rating consensus process as the assessors discuss the participant's performance and come to agreement on each final competency rating.

To further describe traditional techniques for producing assessment reports, and to illustrate the amount of human judgment involved in this technique, FIG. 2 provides a sample logic flow for an assessment center. As shown in the leftmost column of FIG. 2, an assessment participant may participate in multiple simulations, labeled Simulation A, Simulation B and Simulation C. Each simulation is designed to elicit behaviors from the participant relative to one or more target competencies being assessed. In traditional assessment centers, the individual behaviors sought to be elicited by each simulation are used only as examples of performance in the targeted competency. Additionally, in traditional assessment centers, participants are not required to demonstrate all of the individual behaviors and they are not rated separately from competency ratings.

One or more first assessors may initially rate the target competencies as observed in the initial simulation (Simulation A). Likely different assessors will rate target competencies in the other simulations (Simulations B and C). As shown in the first column from the left of FIG. 2, the competency ratings from each simulation are provided by the one or more assessors, each of whom has applied judgment in rating the competencies at this stage, based upon the assessors' observations of the participant during the simulations they are rating (e.g., at least one of Simulation A, B, or C).

As shown in the second column of FIG. 2, each individual competency can then be assigned a final rating determined from the ratings provided by all of the assessors who rated the competency. This final rating is determined in a meeting of all of the assessors who rated the participant, and a final, consensus competency rating is assigned for each target competency. The assessor assigned to prepare the assessment report and provide feedback to the participant or the participant's manager may then also consider the outcomes from the non-simulation assessment instruments completed by the participant, such as personality inventories, motivation inventories, and experience inventories. As shown in the third column of FIG. 2, this analysis uses the results from the non-simulation assessment instruments to help better understand the competency ratings from the simulations. Personality and other non-simulation attributes are analyzed together with the competency ratings from the simulations in order to prepare an assessment report. The assessment report provides the competency ratings from the simulations as well as an explanation of the competency ratings. The assessment report also separately provides the ratings or other results from each of the non-simulation assessments used in the assessment center (e.g., a personality summary). With this assessment report, the administrating assessor or other feedback provider can provide feedback to the participant or the participant's manager in the form of a feedback discussion.

Regardless of the form of rating provided by each assessment, the result in an assessment center is a set of competency ratings plus reports from any non-simulation assessment instruments used in the assessment center. The assessment center report does not integrate or combine the ratings from each of the assessment instruments into one final competency rating for each target competency. Prior to the feedback discussion with the participant or the participant's supervisor, the individual delivering the feedback reviews all of the assessment reports for the assessed individual. The feedback provider looks for inter-relationships among the results that may reveal deeper insights into the participant's likely behaviors on the job. During the feedback discussion, the feedback provider describes these patterns to the participant. For example, the competency rating for Cultivating Networks from the simulation portion of the assessment center might be high because the participant displayed behaviors required for proficiency in this competency, but the results from the personality assessment instrument may indicate that the participant, while able to perform the competency in the simulation, may not be naturally inclined to do so on a day-to-day basis on the job because, for example, the participant is naturally introverted. During the feedback discussion with the participant or the participant's manager, the feedback provider may observe and describe this pattern and then suggest ways in which the participant can try to improve. Which patterns the feedback provider finds, which insights he or she focuses on in the feedback discussion, and which suggestions the feedback provider gives the participant for the participant's development are all a function of individual judgments at the times of both analysis and the feedback discussion. Furthermore, these observations and insights are provided only in the feedback discussion and not in the competency rating reports. Therefore, the participant must take good notes during the feedback discussion so that he or she can remember later the additional insights (based on data from the non-simulation assessment instruments) described by the feedback provider as well as what the feedback provider suggested for the participant's development.

As described above, the traditional assessment center method involves multiple steps, potentially requires several different assessors, and is performed based upon the individual assessors' own judgments, abilities, training, and experiences at each step. For example, the steps may include: (i) rating competencies (through observation of behavior in each simulation where behavior is present); (ii) coming to consensus on each competency rating with the other assessors who observed the participant in other simulations; (iii) analyzing the various non-simulation assessment reports together with the simulation reports to find patterns among the results in order to provide a deeper level of understanding of the competency ratings for feedback to the participant; and (iv) providing the feedback in the form of a discussion with the participant. The assessor also has to manage time and the direction of the conversation during the feedback discussion so that all of the results and the insights that the assessor determined were most important are actually addressed during that discussion. This clinical and multi-step process, involving a number of human beings in the administration of simulations, rating, integration, and feedback of the outcomes from the various assessment tools used, does provide valid, meaningful and accurate results, but the outcomes could be improved by removing human judgment from most steps in the process.

### SUMMARY

In an embodiment, a method of providing an automated assessment center is described. The method includes, but is not limited to, various functions for performing an automated assessment rating process. A processing device may be configured to perform the various functions. For example, the processing device may determine one or more competencies to assess for an assessment participant, determine a plurality of associated behaviors for each of the one or more competencies to assess, and provide one or more simulations to the assessment participant, wherein the one or more simulations comprise tasks designed to express each of the plurality of behaviors as demonstrated by the assessment participant when completing the one or more simulations. The processing device may also receive a plurality of behavior ratings from a plurality of assessors, wherein each behavior rating comprises a rating for an associated behavior from the plurality of behaviors as demonstrated by the assessment participant when completing the one or more simulations. The processing device may then determine an initial competency rating for each of the one or more competencies to assess and, for each competency, combine the initial competency rating with one or more non-simulation assessment results. The processing device may further determine a final competency rating for each of the one or more competencies to assess based upon the combined initial competency rating and the at least one non-simulation assessment result and generate a report including at least the final competency rating for each of the one or more competencies to assess.

In an alternative embodiment, a system for providing an automated assessment center is described. The system includes a processor and a non-transitory, processor-readable storage medium in communication with the processor. The non-transitory processor-readable storage medium includes one or more programming instructions that, when executed, cause the processor to perform various functions related to the automated assessment center. For example, the instructions may cause the processor to: determine one or more competencies to assess for an assessment participant; determine a plurality of associated behaviors for each of the one or more competencies to assess; provide one or more simulations to the assessment participant, wherein the one or more simulations comprise tasks designed to express each of the plurality of behaviors as demonstrated by the assessment participant when completing the one or more simulations; receive a plurality of behavior ratings from a plurality of assessors, wherein each behavior rating comprises a rating for an associated behavior from the plurality of behaviors as demonstrated by the assessment participant when completing the one or more simulations; determine an initial competency rating for each of the one or more competencies to assess; for each competency, combine the initial competency rating with one or more non-simulation assessment results; determine a final competency rating for each of the one or more competencies to assess based upon the combined initial competency rating and the at least one non-simulation assessment result; and generate a report including at least the final competency rating for each of the one or more competencies to assess.

In another embodiment, a method of providing an automated assessment center is described. The method includes, but is not limited to, various functions for performing an automated assessment rating process. A processing device may be configured to perform the various functions. For example, the processing device may provide one or more assessments to an assessment participant, wherein the one or more assessments comprise tasks designed to express each of a plurality of behaviors associated with one or more competencies to be assessed as demonstrated by the assessment participant when completing the one or more assessments. The processing device may then receive a plurality of behavior ratings from a plurality of assessors, wherein each behavior rating comprises a rating for an associated behavior as demonstrated by the assessment participant when completing the one or more assessments. The processing device may also determine an initial competency rating for each of the one or more competencies to assess and, for each competency, combine the initial competency rating with one or more non-simulation assessment results. The processing device may further determine a final competency rating for each of the one or more competencies to assess based upon the combined initial competency rating and the at least one non-simulation assessment result and generate a report including at least the final competency rating for each of the one or more competencies to assess, wherein the report further includes a listing of one or more topic for a feedback discussion between the assessment participant and an assessment administrator.

### BRIEF DESCRIPTION OF THE DRAWINGS

FIG. 1 illustrates a flow diagram of a method of using an assessment platform according to traditional techniques.

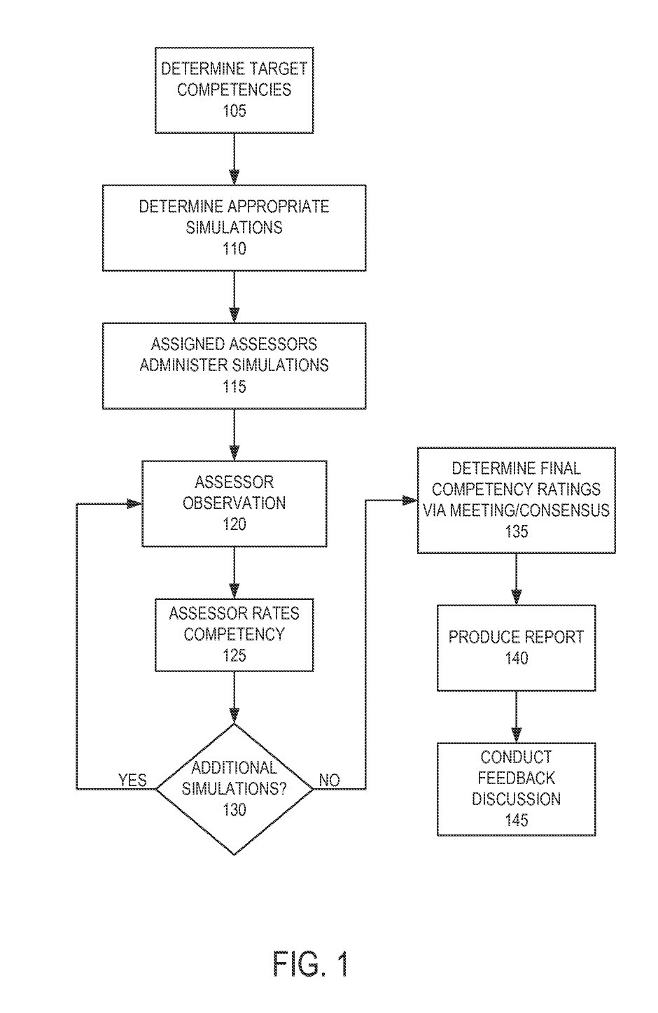

FIG. 2 illustrates a logic flow of an assessment platform according to traditional techniques.

FIG. 3 depicts a general schematic representation of an operating environment arranged in accordance with an embodiment.

FIG. 4 depicts a block diagram of a plurality of modules used by one or more programming instructions according to an embodiment.

FIG. 5 depicts a flow diagram of a method of using an automated assessment rating and reporting platform according to an embodiment.

FIG. 6 depicts a sample logic flow of an assessment process according to an embodiment.

FIG. 7 depicts an example of a set of roll-up tables used in automated rating according to an embodiment.

FIG. 8 depicts a block diagram of illustrative internal hardware that may be used to contain or implement program instructions according to various embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “electronic device” refers to a device that includes a processor and a tangible, computer-readable memory. The memory may contain programming instructions that, when executed by the processor, cause the device to perform one or more operations according to the programming instructions. Examples of electronic devices include, but are not limited to, personal computers, gaming systems, televisions, and mobile devices.

A “mobile device” refers to an electronic device that is generally portable in size and nature. Accordingly, a user may transport a mobile device with relative ease. Examples of mobile devices include pagers, cellular phones, feature phones, smartphones, personal digital assistants (PDAs), cameras, tablet computers, phone-tablet hybrid devices (e.g., “phablets”), laptop computers, netbooks, ultrabooks, global positioning satellite (GPS) navigation devices, in-dash automotive components, media players, watches and the like.

A “computing device” is an electronic device, such as, for example, a computer or components thereof. The computing device can be maintained by entities such as a financial institution, a corporation, a governmental body, a military branch, and/or the like. The computing device may generally contain a memory or other storage device for housing programming instructions, data or information regarding a plurality of applications, data or information regarding a plurality of users and/or the like. The programming instructions may be in the form of the operating environment, as described in greater detail herein, and/or contain one or more modules, such as software modules for carrying out tasks as described in greater detail herein. The data may optionally be contained in a database, which is stored in the memory or other storage device. The data may optionally be secured by any method now known or later developed for securing data. The computing device may further be in operable communication with one or more electronic devices. The communication between the computing device and each of the electronic devices may further be secured by any method now known or later developed for securing transmissions or other forms of communication.

A “server” is a computing device or components thereof that generally provide data storage capabilities for one or more computing devices. The server can be independently operable from other computing devices and may optionally be configured to store data in a database, a memory or other storage device. The server may optionally contain one or more programming instructions, such as programming instructions in the form of the operating environment, as described in greater detail herein, and/or one or more modules, such as software modules for carrying out tasks as described in greater detail herein. The server may have one or more security features to ensure the security of data stored within the memory or other storage device. Examples of security features may include, but are not limited to, encryption features, authentication features, password protection features, redundant data features and/or any other security features now known or later developed. The server may optionally be in operable communication with any of the electronic devices and/or computing devices described herein and may further be secured by any method now known or later developed for securing stored data, data transmissions or other forms of securing electronic information.

An “automated assessment” is a system and/or a method contained within an application environment that includes programming instructions for providing an assessment tool for the evaluation of responses elicited by important and representative tasks in the target job and/or a job level for which the participant is being evaluated. The automated assessment may further be used to present tasks that elicit one or more responses from participants related to individual behaviors or particular contexts. The system automatically associates ratings to one or more behaviors with one or more competencies and computes individual behavior, competency, overall ratings and narrative descriptions of observed behaviors for the assessment report. These individual behaviors and competency levels may be used to assess how adept or prepared a participant is for a particular job, for tasks to be completed within a particular job and/or the like.

A “participant” is a user, such as the user of an electronic device, which completes an assessment as described herein. The participant may be an individual that uses the automated assessment, such as a prospective employee of an organization, a current employee, a person of interest and/or the like. The participant may generally agree to take an assessment with an organization and may connect to the one or more servers, as described herein, to schedule and complete the assessment.

The present disclosure is directed to an automated process for rating, integrating, and reporting for assessment centers, based upon research, that takes the place of the traditional manual, clinical process, and corrects for the natural variations created through the use of differently trained, differently skilled, and differently experienced assessors. This correction occurs by rating individual behaviors, not just competencies, and by using one consistent set of decision rules for rating, integrating ratings, and interpreting multiple assessment instrument results into one cohesive assessment center with one combined report that provides overall competency ratings as determined using the techniques of potentially multiple types of assessment instruments. Although assessors use human judgment to rate the observed behaviors present in the simulation portion of the assessment center, the overall competency rating and the analysis processes treat each assessed participant exactly the same, without any human biases.

The present disclosure modifies the traditional assessment center method for rating and reporting results in various ways: (i) rating takes place at the individual behavior level instead of the competency level, with only pre-defined individual behaviors being rated, and these individual behavior ratings from each simulation are combined into overall behavior ratings, which are then grouped by competency; (ii) the assessor group discussion for generating a consensus competency rating for each target competency is eliminated and replaced by a mathematical, algorithmic process for analyzing and combining behavior ratings from multiple simulations and transforming them into competency ratings in a consistent and reliable way that decreases the potential for variations due to human judgment differences among assessors; (iii) a new rating function is added wherein the competency ratings from simulations are compiled, analyzed, combined with, and integrated with non-simulation assessment instrument ratings in a repetitive and sequential order (or, for example, iteratively through the rating system), via a mathematical algorithm or process that rolls competency ratings with and into non-simulation assessment instrument attribute, to create an overall, combined competency rating for each competency that is more reflective of the participant's true performance in each competency; and (iv) reporting is comprehensive and complete, requiring less discussion with the participant, and is targeted at specific behaviors that require development instead of being tied just to competencies, so that time and money are not wasted developing behaviors that are already strong, and development is not overlooked for behaviors that are weak. The modified process changes enable a mathematical, algorithmic approach to the overall competency rating, analyzing, and reporting process, based upon research, instead of the manual, clinical process used in the traditional assessment center.

In the present disclosure, rating begins, for the simulation rating portion of the assessment center, at the individual behavior level, not at the competency level. Similarly, unlike the traditional simulation and assessment techniques as described above, this is the only portion of the simulation where human assessor judgment is applied. The individual behaviors that collectively define each competency may be predefined in the simulations for the assessors as described herein, and each such behavior may be rated separately.

In a traditional simulation, the behaviors that make up a competency are provided to assessors as examples of possible behaviors that demonstrate a target competency, and the participant does not need to demonstrate all of them in order to show proficiency at the competency. The behaviors are not separately rated in a traditional simulation; rather, they are observed as demonstrated by the participant and used to determine an overall competency rating as the first rated step. Conversely, the present disclosure teaches pre-determined behaviors that should be demonstrated to show proficiency in the competency and requires that each defined behavior be rated. The simulations are designed specifically to elicit these behaviors. If any behaviors are missing in the participant's performance, that lack of demonstration of the required behaviors counts against the participant. Additionally, if a participant displays behaviors that were not specifically targeted by a simulation, the assessor does not have the liberty to count those behaviors towards a competency rating. This rule reduces the unreliability introduced by allowing assessors to use their judgment and interpretation to rate behaviors that were not specifically targeted. Because each participant is expected to demonstrate the same important behaviors, highly reliable ratings for the behaviors may be made by the assessors. The baseline for rating all participants going through the same simulations is more consistent and less subject to individual assessor observations, skills, experience, and biases than in the traditional simulation rating process.

The many behavior-level ratings from each simulation are combined algorithmically into overall behavior ratings by the automated assessment system. The behavior ratings are then combined, for example, via a repetitive and sequential and/or iterative process, and transformed into competency ratings, without the need for an assessor group meeting to discuss competency results and arrive at a consensus rating for each competency. The consistency of this process produces competency rating results that are more reliable and less prone to variations based upon the human judgments of the assessors. It also saves time and money. The competency ratings may then be compared to and combined with the relevant information from the non-simulation assessments used in the assessment center that rate competencies. Ratings from the personality and experience portions of the assessment center that do not specifically produce a competency rating are also factored into the competency ratings through a unique algorithm or process, thereby arriving at final ratings for each competency measured. Because the non-simulation assessment instrument ratings are factored directly and algorithmically into each overall competency rating, more nuances are captured and considered for each competency than in a traditional assessment center.

For example, the overall rating for the competency Delegation could be derived 78% from simulations and 22% from specific personality attributes found in a personality inventory. A different example would be Leading Change, which could be derived by weighting the assessment inputs as follows: 21% from the motivation instrument rating, 51% from specific personality attributes found in a personality inventory, 11% from the experience instrument rating, and 17% from the behavioral simulations ratings. The weight given to the rating from each assessment tool varies from competency to competency, based upon research. Therefore, the resulting overall rating for each competency is the most complete and meaningful view of that competency for that individual. The way each overall competency rating is derived is the same each time the assessment center is run. The way that personality, motivation, or experience ratings are weighted for each competency and factored into the overall competency rating is also the same each time the assessment center is run. This consistent process for analyzing the ratings from each of the assessments used in the assessment center and transforming them into one cohesive competency rating is a function that is missing in traditional clinical assessment methods.

The present disclosure also introduces a consistent statistical approach to creating fully integrated feedback to the participant or the participant's manager based upon research, via an automated process, instead of using a clinical approach, via dependence upon a trained assessor. The system analyzes results and detects behavioral patterns among the competency and behavior-level ratings derived from each assessment instrument without human input. The system then uses these results to provide deeper and fuller insights regarding the participant's behaviors than are obtained from looking at the results from one assessment instrument alone or one assessment instrument at a time, or from merely looking at results at the competency level.

The system analyzes detected patterns and their meanings electronically, according to predetermined parameters based on company strategy and plans, and provides the participant with an overall, interactive, electronic feedback report navigated by the participant as he or she chooses. The system uses the combined assessed views of the participant to suggest development opportunities for the participant that are more targeted toward personal development and achievement of the organization's goals, and that are more consistent across all participants than is achievable where human assessors review feedback reports from separate assessment instruments, detect the patterns, and interpret them for each participant.

In the present disclosure, reports focus on behavior-level data and interpretations, not just competency-level data and interpretations. This change allows the reporting to both the company's management and to the participant to be more specific. Knowing what was stronger or weaker at the individual behavior level makes it easier for the participant and the participant's boss to understand the assessment center results. It also makes it easier for the participant and participant's manager to plan for development that will make a difference in the participant's performance on the job. To illustrate this point, consider that a participant could be strong in two of the behaviors that make up a target competency and weak in three. In the traditional assessment center method, this participant might get a poor overall rating for the competency. Development may be targeted, in part, at behaviors that are already strengths for the participant, thus wasting the participant's and the company's time and money. As described herein, the participant might still receive a poor rating for the competency, but in this case, the participant and his or her manager would know which specific behaviors require development. The negative psychological impact of a poor competency rating would also be lessened for the participant, because it would be tempered by a suggestion for development only for those behaviors making up the competency that actually require improvement. The participant would see that two of the behaviors are already proficiencies. Seen another way, in a traditional assessment center, if the rating for a competency is a “3,” or “proficient,” the participant might still have failed to exhibit important component behaviors in the simulations, but potentially no development would be suggested for this competency during the feedback session. The participant would not realize there was an area requiring improvement. In the present method, that participant may or may not receive a “proficient” rating in this case, but regardless, development for the weak behaviors would be suggested.

The modification to the reporting and feedback process allows the participant to review a comprehensive report of his or her results prior to the feedback session with the feedback provider. The feedback report does not require as much explanation as the multiple competency ratings and separate reports provided in the traditional assessment center. In the traditional assessment center, the competency ratings and other reports have not been integrated into one cohesive set of competency ratings and explanations at the time they are provided to the participant or the participant's manager. Therefore, the feedback sessions can be more targeted to discussing how the participant can focus his or her development, as opposed to being focused largely on explaining the meaning of the results from the various assessment instruments and how they work together. This creates an enhanced feedback experience for the participant, as well as time and cost efficiencies.

The rating and reporting methodology as described herein provides higher reliability because each assessed individual's competencies are rated in exactly the same manner, based upon research, and the reporting and analysis of the intersections of the results from the various assessment instruments used are also created using the exact same methods. This process fixes the problem of relying upon human judgment at every step in the assessment rating, interpretation, and feedback processes. Using one cohesive, expert methodology removes the issues inherent in the different standards and training of assessors, as well as the different levels of experience among assessors, all of which contribute to the inconsistencies found in traditional clinical methods of rating and reporting assessments. The process uses combined expert analyses to provide a depth of collective knowledge and experience that is greater than that of any one assessor. Moreover, such analyses can be improved and refined over time as data from a large number of participants is collected. The result is a clearer picture showing proficiency, or what an employee or employment candidate “can do,” as well as a picture of what the individual or group “will do.”

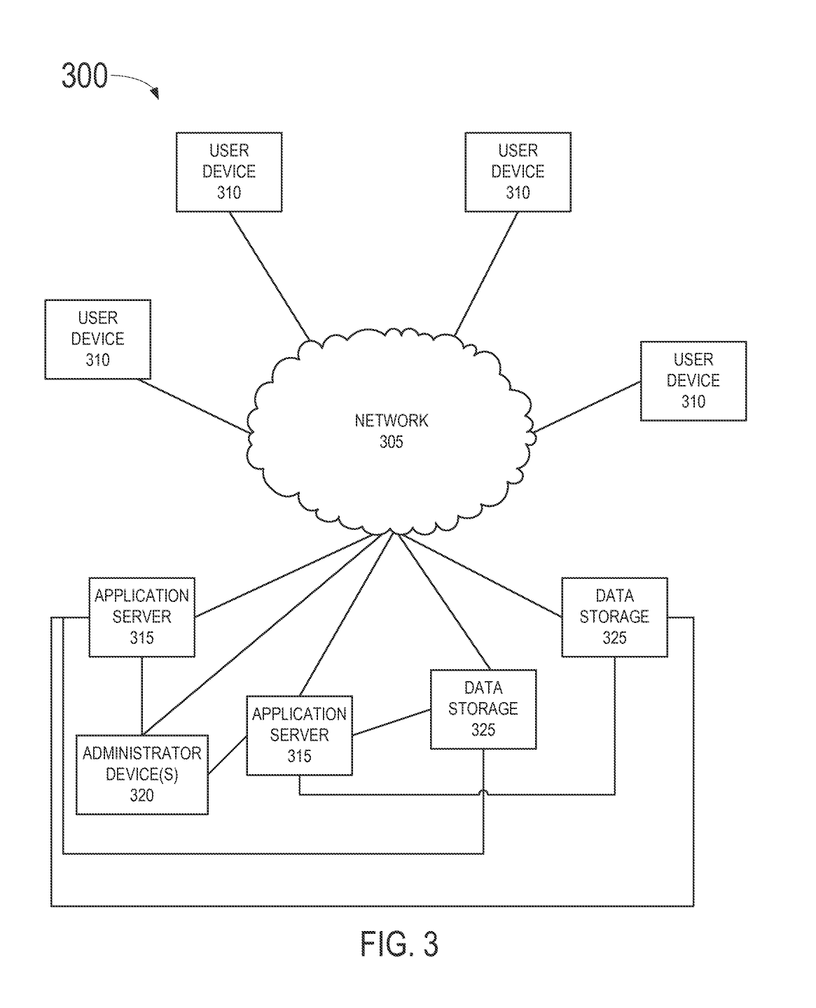

FIG. 3 depicts a block diagram of an illustrative system, generally designated 300, for providing an interface to a plurality of users according to an embodiment. The system may generally include a plurality of user devices 310 connected via a network 305. Thus, each of the various user devices 310 may be interconnected with one or more networking devices and may use any networking protocol now known or later developed. For example, the user devices 310 may be interconnected via the Internet, an intranet, a wide area network, a metropolitan area network, a local area network, a campus area network, a virtual private network, a personal network, and/or the like. The network 305 may include a wired network or a wireless network. Those having ordinary skill in the art will recognize various wired and wireless technologies that may be used for the network 305 without departing from the scope of the present disclosure.

In various embodiments, the network 305 may allow the plurality of user devices 310 to connect to one or more of an application server 315, an administrator device 320, and a data storage device 325. Additional or fewer devices may also connect to the plurality of user devices 310 via the network 305 without departing from the scope of this disclosure. For example, in some embodiments, the network 305 may permit access to one or more external databases.

In various embodiments, each user device 310 may generally provide a connection for at least one user to the network 305 and/or another user (via another user device). Thus, a user device 310 may be any type of electronic device, computing device, mobile device, and/or the like. In some embodiments, each user device 310 may be configured for the particular user that uses the device.

For example, a user device 310 may be configured to provide a user such as an assessment participant with additional information related to the assessment process and simulations as well as access to an assessment module, a simulation module, and/or the like. In another example, a user device 310 may be configured to provide a user such as an assessment administrator or assessor with information related to individual behaviors and associated competencies, information about an assessment participant, and access to an assessment module, a rating module, a reporting module, and/or the like. In another example, a user device 310 may be configured to provide a user such as an assessment administrator or assessor with information about groups of participants at the same organization that have gone through the same assessment center. Such configurations of a user device 310 may be provided via one or more software applications, web-based applications, hardware, and/or the like. In some embodiments, a user device 310 may be configured to provide an interface from an application server 315, such as the communication interface as described in greater detail below.

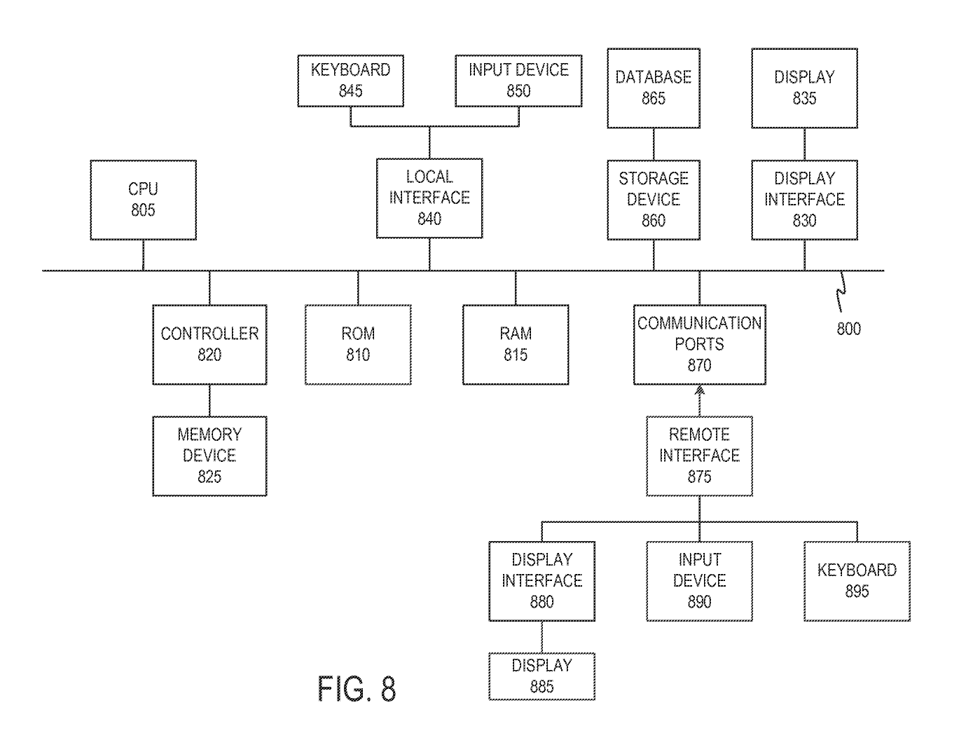

In another example, if a user device 310 is a mobile device such as a smartphone, the user may use a smartphone application (“app”) to complete various tasks, as described in greater detail herein. A software application, web-based application, and/or the like may be configured to use various hardware portions of a user device 310, such as, for example, a camera, an input device, a sensor, and/or the like. Accordingly, the user device 310 may generally contain any hardware necessary for carrying out at least the various processes described herein. Illustrative hardware is described herein with respect to FIG. 8.

In various embodiments, the user device 310 may be configured to receive information from a user. In some embodiments, the user device 310 may be configured to provide information to a user. Illustrative information may include, but is not limited to, login information such as user ID and/or password information for use in identifying a user associated with a user device 310 and any associated account or personal data for that user, assessment information, assessment participant information, assessment administrator and assessor information, and/or the like.

In various embodiments, the user device 310 may be configured to communicate with one or more other devices, such as, for example, other user devices, the application server 315, an administrator device 320, and/or a data storage device 325. Communication between the user device 310 and one or more of the other devices may generally be completed via the network 305. Such inter-device communication may include, but is not limited to, email messages, text messages, voicemail messages or other similar audio based messages, video messages such as a short video or a video chat session, and other similar messaging types.

In some embodiments, a first user device 310 may communicate with one or more second user devices when a user of the first user device receives assistance from the user of a second user device, as described in greater detail herein. In some embodiments, a user device 310 may communicate with an application server 315 to transmit software application information, as described in greater detail herein. In some embodiments, a user device 310 may communicate with an administrator device 320 for the purposes of transmitting administrative and/or technical data, as described in greater detail herein. In some embodiments, a user device 310 may communicate with a data storage device 325 to transmit data, as described in greater detail herein.

An application server 315 may generally provide one or more applications, modules, and/or the like to a user at a specific user device 310 via the network 305. For example, an application server 315 may contain a memory having one or more programming instructions that cause a processing device associated with the application server to provide the one or more applications, modules, and/or the like to a user device 310. In some embodiments, an application server 315 may be configured to provide an assessment and simulation application or module to an assessment participant at a user device 310. In some embodiments, an application server 315 may be configured to provide a rating and reporting application or module to an assessment administrator or assessor at a user device 310. In some embodiments, an application server 315 may be configured to provide a research application or module.

The administrator device 320 may generally be an electronic device for use by a network or system administrator having device access and privileges above a typical system user. For example, a network administrator may use the administrator device 320 to maintain an application server 315, to communicate with users, to perform administrative functions, to retrieve administrative data, and/or the like. In some embodiments, the administrator device 320 may be essentially similar to a user device 310, but have administrator privileges not provided to the user device. In some embodiments, the administrator device 320 may connect directly to other devices such as an application server 315. In other embodiments, the administrator device 320 may connect to other devices via the network 305.

A data storage device 325 may generally store data that may be used for one or more of the functions described herein. In addition, data used for various modules, such as teaching modules, research modules, and/or the like may be stored in a data storage device 325. Accordingly, a data storage device 325 may be any electronic device that is configured to store data. Illustrative data storage devices may include, but are not limited to, hard disk drives, removable storage drives, flash memory devices, data servers, cloud-based storage solutions, and/or the like. In some embodiments, a data storage device 325 may be a portion of an application server 315 or directly connected to the application server. In other embodiments, a data storage device 325 may be a standalone device that is separate from a user device 310 and an application server 315. For example, in some embodiments, a data storage device 325 may be located at an offsite facility, and an application server 315 may be located at an administrator facility.

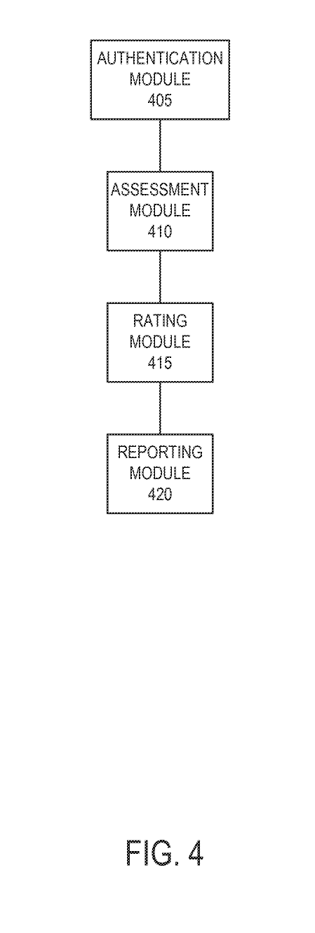

One or more of the devices described with respect to FIG. 3 may be used, either alone or in combination, to carry out one or more processes described with respect to the following figures and related discussion. Similarly, FIG. 4 depicts a diagram of the various modules completed by an application environment operating, for example, on one or more of the devices as described in FIG. 3.

In FIG. 4, the application environment may complete the various operations as described in greater detail herein within an authentication module 405, an assessment module 410, a rating module 415 and a reporting module 420. The authentication module 405 may generally contain operations for scheduling an assessment and authenticating a participant, as described in greater detail herein. The assessment module 410 may generally contain operations for providing simulations, obtaining participant responses and assessment measurements and the like to allow the participant to complete an assessment as well as an orientation to the simulated target job and/or level embedded in the simulation. The rating module 415 may generally contain operations for automatically evaluating participants, automatically creating ratings at various rating levels, computing competency ratings and/or the like based upon measurements obtained in the assessment module 410. The rating module may include human and computer-generated evaluations of the participant's behavior and methods to combine ratings at various levels, such as individual behaviors, overall rating, feedback statements and/or situational insights). The reporting module 420 may generally contain operations for compiling a report based upon the rating and providing the report to individuals and/or entities. The modules described herein are merely illustrative and those skilled in the art will recognize that additional and/or alternate modules for completing one or more operations may be used without departing from the scope of the present disclosure. Furthermore, each module disclosed herein may contain one or more submodules. In certain embodiments, the submodules may be shared by a plurality of modules. In other embodiments, the modules described herein may be a submodule of another module (e.g., the reporting module may be a portion of the rating module). In some embodiments, each module may operate concurrently with another module. In other embodiments, the modules may operate in succession to one another.

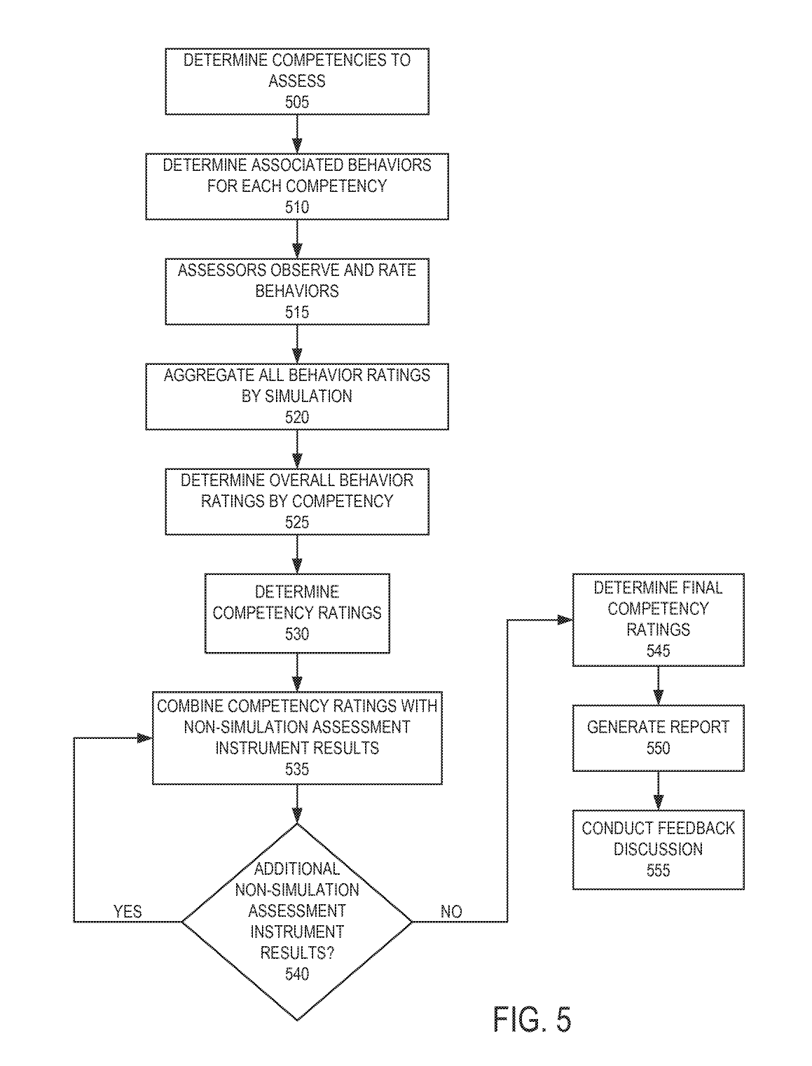

FIG. 5 illustrates a flow diagram illustrating a sample process for automatically rating and reporting a participant's assessment center using an automated assessment system. An administrator may determine one or more competencies to assess for one or more participants and may determine 505 the competencies to assess. Examples of competencies may include, but are not limited to, Managing Relationships, Guiding Interactions, coaching for Success, Coaching for Improvement, Influencing, Delegation and Empowerment, Problem and/or Opportunity Analysis, Judgment, Driving Execution, Leading Change, Cultivating Networks, and Planning and Organizing.

The Managing Relationships competency, for example, may generally be used to observe how the participant is able to meet the personal needs of individuals to build trust, encourage two-way communication and strengthen relationships. The Coaching for Success competency may generally be used to observe how the participant is able to prepare teams and individuals to excel in new challenges through proactive support, guidance and encouragement. As previously described herein, each competency may include three or more individual behaviors. For example, in a specific example embodiment, each competency may require three or more individual behaviors. In other embodiments, a competency may include 4 individual behaviors, and so forth. The individual behaviors are behaviors that research and job analysis has found critical for effective performance of a competency in a target job and/or job level. Each simulation presented to the participant may be targeted to assist the assessors in evaluating one or more of these individual behaviors. Examples of the individual behaviors include, but are not limited to, maintain self-esteem, show empathy, provide support without removing responsibility, state the purpose and importance of meetings, clarify issues, develop and/or build others' ideas, check for understanding, summarize and/or the like.

Referring again to FIG. 5, the assessment system may determine 510 the associated behaviors (or, as noted above, for specific example embodiments, the required behaviors) for each competency indicated as being assessed for a specific participant. As noted above, each competency may have a set number of associated behaviors that correspond to that particular competency. Based upon the determined 510 behaviors, a participant being rated through the automated assessment system may participate in one or more simulations mapped to the determined behaviors. As noted above, one or more assessors may 515 observe and rate the individual behaviors in a simulation, and the automated assessment system may receive the multiple behavior ratings from the assessors.

The automated assessment system may 520 aggregate and band all of the behavior ratings (from all of the simulations that are linked to a given competency) into overall behavior ratings once all behavior ratings have been received from the assessors. The automated assessment system may further determine 525 and aggregate each overall behavior rating by competency.

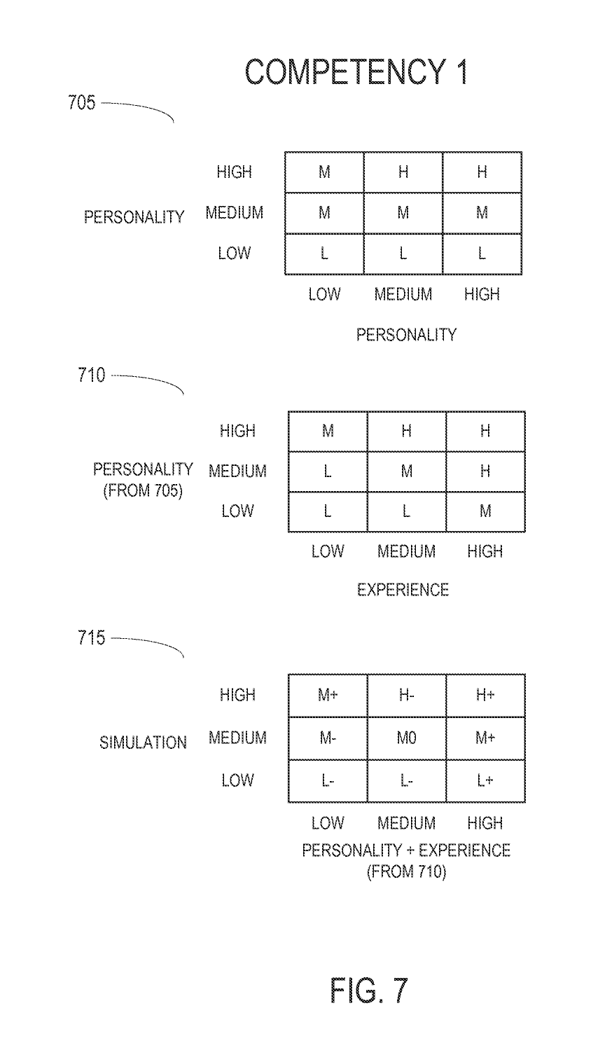

When the automated assessment system determines that all required behavior ratings from all simulations have been received from the assessors, and there are no additional behavior ratings for any specific competencies, the automated assessment system may determine 530 the competency ratings by transforming the behavior ratings into competency ratings, weighting each required behavior rating for a given competency as determined based upon the implementation of the assessment system or other particular features that may impact overall job performance in a target job within an organization. The automated assessment system may combine the competency ratings and non-simulation assessment instrument ratings by repetitively and sequentially and/or iteratively combining 535 the competency ratings with non-simulation assessment instrument results by, for example, populating and calculating rollup tables that integrate simulation competency ratings with the ratings from the non-simulation assessment instruments. A roll-up table, as used herein, refers to one or more data structures representing the rating for each competency or non-simulation assessment instrument attribute (i.e., personality, motivation, and experience). Examples of roll-up tables are shown in FIG. 7 and described in detail below. The automated assessment system may determine 540 if there are additional non-simulation assessment instrument results and, if there are, iteratively repeat combining 535 the competency ratings with the non-simulation assessment instrument results. Thus, by iteratively repeating this process, all simulation competency ratings and non-simulation assessment instrument ratings are combined 535 using rollup tables until all of the inputs have been factored into the ratings.

Additionally, this integration and comparison process, using rollup tables, allows for the differential weighting of simulation and non-simulation ratings that produces a final competency rating that is a deeper, more rounded expression of the participant's true likely future performance on the job in the competencies assessed. Thus, based upon the integration and comparison process, the automated assessment system may determine 545 a set of final competency ratings. Based upon these final competency ratings, the automated assessment system may generate 550 a final assessment report, which the feedback provider may use to conduct 555 a feedback discussion with the participant or the participant's manager. For example, the final assessment report may include the final competency ratings for each competency assessed for a particular participant, a listing of recommended developmental activities for the particular participant to undertake to, for example, potentially improve any competencies identified as weak or otherwise lacking for the participant, and other similar feedback information determined by the automated assessment system.

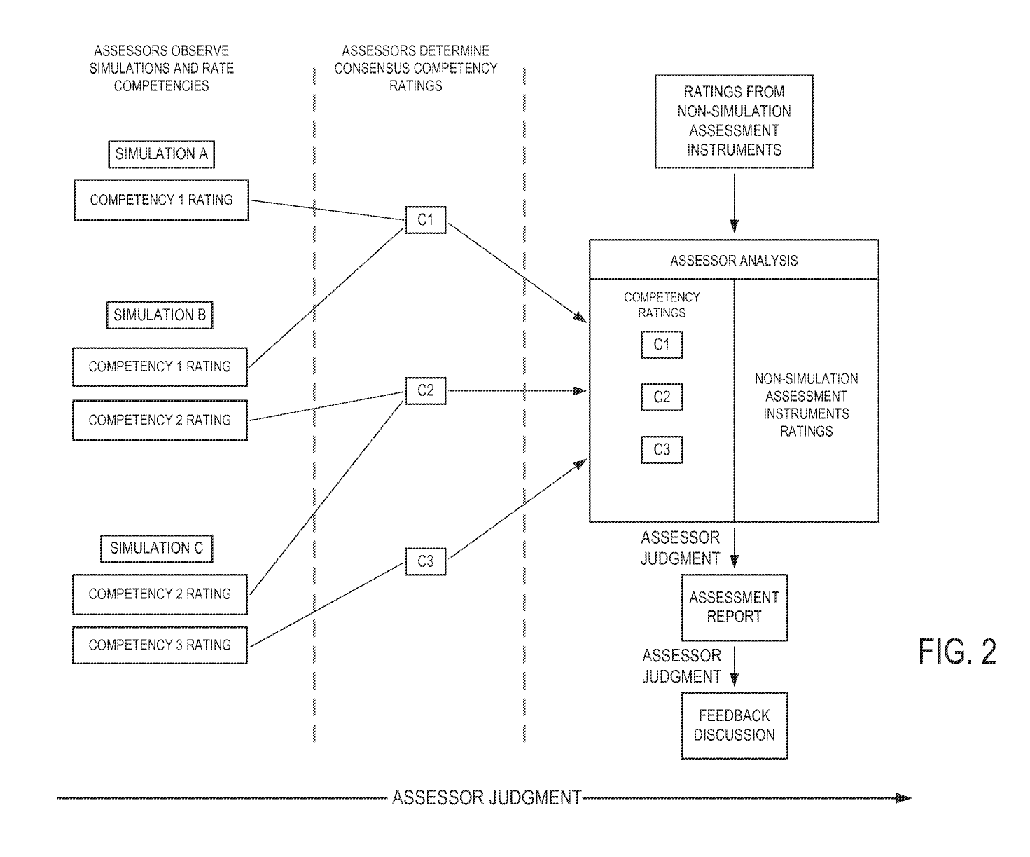

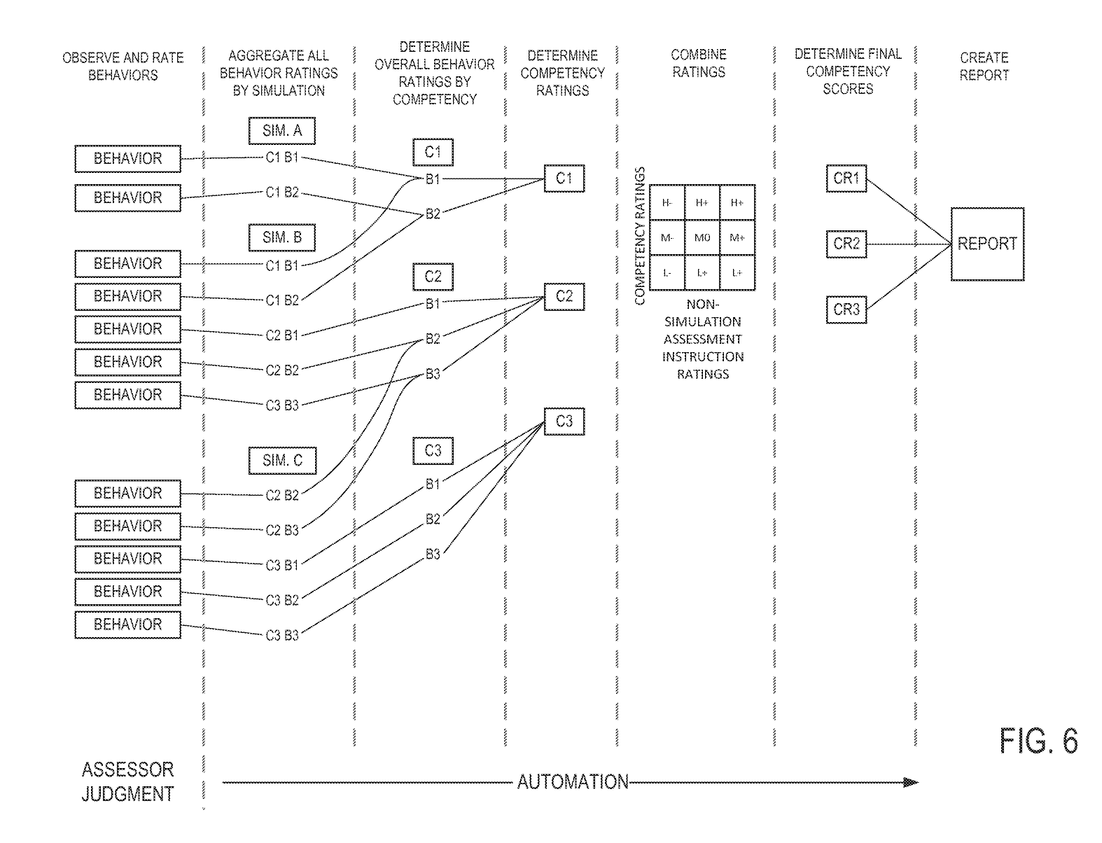

FIG. 6 illustrates a sample logic flow of data being transformed in, for example, the automated rating process as described above in regard to FIG. 5. FIG. 6 is similar in overall scope and appearance as the logic flow as shown in FIG. 2. However, there are several key differences in the logic flow of FIG. 6 that define over the traditional techniques.

Initially, as shown on the left of FIG. 6, a set of determined behaviors for each competency is observed and, as shown in the second column of FIG. 6, rated based upon one or more assessors' judgments. However, after this initial judgment stage, all rating is automated and performed by the automated assessment system as described herein, including the final report generation. Thus, the behavior ratings from the initial simulations (e.g., Simulation A, Simulation B and Simulation C) are automatically processed into overall behavior ratings grouped by competency, as shown in the third column of FIG. 6. From these overall behavior ratings, competency ratings are determined, as shown in the fourth column of FIG. 6. Then, as shown in the fifth column of FIG. 6, the ratings from the non-simulation assessment instruments are factored into and combined with the competency ratings from the simulations. This is done through the iterative use of rollup tables as is depicted in FIG. 7 and is described in more detail below.

Together with the individual competency ratings and the self-reported non-simulation assessment instrument ratings, the automated assessment system may automatically, and without human intervention, based on a scientific method, generate the assessment report, as shown in the sixth column of FIG. 6, including comprehensive competency ratings for each specific competency being assessed. As described above, the feedback provider may use this integrated report to provide information during the feedback discussion with the participant or the participant's manager. Thus, as described above, various shortcomings of the prior art resulting from human biases are eliminated.

FIG. 7 illustrates a sample set of roll-up tables generated, for example, during the rating of Competency 1 using a process similar to that as shown in FIG. 5. It should be noted that the rating notations used and sample attributes shown as being combined in the sample roll-up tables depicted in FIG. 7 are shown by way of example only as types of ratings and combinations of rated attributes that may be included in the various roll-up tables as described herein in the present disclosure. Depending upon the number of assessment instruments used (both simulation and non-simulation), each competency may have a varying number of roll-up tables that are generated when determining its associated competency rating. Thus, FIG. 7 illustrates three roll-up tables used to determine a competency rating from personality, experience, and simulation ratings, by way of example only.

The first roll-up table 705 may include a visual representation of the ratings from a personality assessment for Competency 1 as combined with an additional measurement such as the rating from another personality assessment. The roll-up table may be referred to by the automated assessment system to quickly determine a rating for the combined aggregated personality rating from the first personality assessment instrument and the additional personality rating from the second personality instrument. For example, if the aggregated personality rating for Competency 1 is High, and the participant's additional personality rating measurement is Medium, an overall rating of High for the combination of aggregated personality rating 1 and additional personality rating 2 would be determined. The rating results from this first rollup table process are then carried forward 710 into the second rollup table, which may include a visual representation of the combination from the first table, rolled up with a rating from a non-simulation assessment instrument evaluating the participant's past experience. If the rating determined by the first rollup table is High and the rating from the experience assessment instrument is Medium, the resulting rating from the second rollup table process would be, in this example, High. The automated assessment system may then refer to the third roll-up table 715, which includes a visual representation of rating for the combination of rollup tables one and two (aggregating two personality ratings and an experience rating). To continue the above example, if the simulations competency rating is Medium, and the personality plus experience integrated rating is High, the overall competency rating after processing through all three rollup tables for this competency would be Medium-Plus (M+) in this example.

By providing individual roll-up tables for each competency, one or more additional measurement ratings (e.g., behavior, personality, motivation, or experience) that contribute to an overall competency rating can be weighted differently. Thus, while multiple competencies may include similar sets of associated behaviors, each behavior rating, as weighted and combined with the additional measurement rating for the competency, may impact that individual competency differently.

It should be noted that the process flow as shown in FIG. 5, the logic flow as shown in FIG. 6, and the roll-up tables as shown in FIG. 7 are provided by way of example only, and are not intended to limit the present disclosure. Rather, the present disclosure, and the teachings as described herein, may be modified and adjusted as necessary based upon the specific implementation of the automated assessment system as taught herein. For example, the specific order of the process steps as shown in FIG. 5 may be altered based upon the implementation of the techniques described herein. Similarly, the number of roll-up tables associated with each competency (and, thusly, the number of behaviors associated with each competency) may vary based upon the implementation of the automated assessment system.

Additionally, it should be noted that the techniques, processes, methods and systems as described herein are directed to an automated assessment center for evaluating job suitability by way of example only. In application, the teachings as included herein may be applied to additional areas of study and evaluation where participants' responses to simulations or other similar exercises are appropriately rated and weighted for determining an overall competency or ability rating.

FIG. 8 depicts a block diagram of illustrative internal hardware that may be used to contain or implement program instructions, such as the process steps discussed herein, according to various embodiments. A bus 800 may serve as the main information highway interconnecting the other illustrated components of the hardware. A CPU 805 is the central processing unit of the system, performing calculations and logic operations required to execute a program. The CPU 805, alone or in conjunction with one or more of the other elements disclosed in FIG. 8, is an illustrative processing device, computing device or processing device as such terms are used within this disclosure. Read only memory (ROM) 810 and random access memory (RAM) 815 constitute illustrative memory devices (such as, for example, processing device-readable non-transitory storage media).

A controller 820 interfaces with one or more optional memory devices 825 to the system bus 800. These memory devices 825 may include, for example, an external or internal DVD drive, a CD ROM drive, a hard drive, flash memory, a USB drive, or the like. As indicated previously, these various drives and controllers are optional devices.

Program instructions, software, or interactive modules for providing the interface and performing any querying or analysis associated with one or more data sets may be stored in the ROM 810 and/or the RAM 815. Optionally, the program instructions may be stored on a tangible computer-readable medium such as a compact disk, a digital disk, flash memory, a memory card, a USB drive, an optical disc storage medium, such as a Blu-ray™ disc, and/or other non-transitory storage media.

An optional display interface 830 may permit information from the bus 800 to be displayed on the display 835 in audio, visual, graphic, or alphanumeric format, such as the interface previously described herein.

The hardware may also include a local interface 840 which allows for receipt of data from input devices such as a keyboard 845 or other input device 850 such as a mouse, a joystick, a touch screen, a remote control, a pointing device, a video input device and/or an audio input device.

The hardware may also include a storage device 860 such as, for example, a connected storage device, a server, and an offsite remote storage device. Illustrative offsite remote storage devices may include hard disk drives, optical drives, tape drives, cloud storage drives, and/or the like. The storage device 860 may be configured to store data as described herein, which may optionally be stored on a database 865. The database 865 may be configured to store information in such a manner that it can be indexed and searched, as described herein.

Communication with external devices, such as a print device or a remote computing device, may occur using various communication ports 870. An illustrative communication port 870 may be attached to a communications network, such as the Internet, an intranet, or the like. As shown in FIG. 8, a remote device may be operably connected to the communications port 870 via a remote interface 875. The remove device may include, for example, a display interface 880 with a connected display 885, an input device 890 and a keyboard 895.

The computing device of FIG. 8 and/or components thereof may be used to carry out the various processes as described herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, processes, systems and techniques, which can, of course, vary. It is also to be understood that the terminology used herein is for the purpose of describing particular embodiments only, and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of providing an automated assessment center, the method comprising:
determining, by a processing device, one or more competencies to assess for an assessment participant;
determining, by the processing device, a plurality of associated behaviors for each of the one or more competencies to assess;
providing, by the processing device, one or more simulations to the assessment participant, wherein the one or more simulations comprise tasks designed to express each of the plurality of associated behaviors as demonstrated by the assessment participant when completing the one or more simulations;
receiving, by the processing device, a plurality of behavior ratings from a plurality of assessors, wherein each behavior rating comprises a rating for an associated behavior from the plurality of associated behaviors as demonstrated by the assessment participant when completing the one or more simulations;
determining, by the processing device, an initial competency rating for each of the one or more competencies to assess;
for each competency, combining, by the processing device, the initial competency rating with one or more non-simulation assessment results;
determining, by the processing device, a final competency rating for each of the one or more competencies to assess based upon the combined initial competency rating and the at least one non-simulation assessment result; and
generating, by the processing device, a report including at least the final competency rating for each of the one or more competencies to assess.

2. The method of claim 1, further comprising aggregating, by the processing device, at least a portion of the plurality of behavior ratings based upon an associated simulation.

3. The method of claim 2, further comprising aggregating, by the processing device, the plurality of behavior ratings based upon an associated competency.

4. The method of claim 1, wherein combining the initial competency rating with at least one non-simulation assessment result for each competency result further comprises generating, by the processing device, at least one roll-up table for each of the one or more non-simulation assessment results.

5. The method of claim 4, wherein the at least one roll-up table comprises a data structure representing the rating for each competency as combined with the one or more non-simulation assessment results.

6. The method of claim 1, wherein the one or more non-simulation assessment results comprise at least one of personality assessment instrument ratings, experience inventory ratings, motivational fit inventory ratings, and multi-rater evaluations ratings.

7. The method of claim 1, wherein each of the one or more competencies comprises three or more associated behaviors.

8. The method of claim 7, wherein at least one behavior is shared by a plurality of competency ratings.

9. A system for providing an automated assessment center, the system comprising:
a processor; and
a non-transitory, processor-readable storage medium in communication with the processor, wherein the non-transitory processor-readable storage medium contains one or more programming instructions that, when executed, cause the processor to:
determine one or more competencies to assess for an assessment participant,
determine a plurality of associated behaviors for each of the one or more competencies to assess,
provide one or more simulations to the assessment participant, wherein the one or more simulations comprise tasks designed to express each of the plurality of associated behaviors as demonstrated by the assessment participant when completing the one or more simulations,
receive a plurality of behavior ratings from a plurality of assessors, wherein each behavior rating comprises a rating for an associated behavior from the plurality of associated behaviors as demonstrated by the assessment participant when completing the one or more simulations,
determine an initial competency rating for each of the one or more competencies to assess,
for each competency, combine the initial competency rating with one or more non-simulation assessment results,
determine a final competency rating for each of the one or more competencies to assess based upon the combined initial competency rating and the at least one non-simulation assessment result, and
generate a report including at least the final competency rating for each of the one or more competencies to assess.

10. The system of claim 9, further comprising one or more programming instructions that, when executed, cause the processor to aggregate at least a portion of the plurality of behavior ratings based upon an associated simulation.

11. The system of claim 10, further comprising one or more programming instructions that, when executed, cause the processor to aggregate the plurality of behavior ratings based upon an associated competency.

12. The system of claim 9, wherein the one or more programming instructions that, when executed, cause the processor to combine the initial competency rating with at least one non-simulation assessment result for each competency result further comprises one or more additional programming instructions that, when executed, cause the processor to generate at least one roll-up table for each of the one or more non-simulation assessment results.

13. The system of claim 12, wherein the at least one roll-up table comprises a data structure representing the rating for each competency as combined with the one or more non-simulation assessment results.

14. The system of claim 9 wherein the one or more non-simulation assessment results comprise at least one of personality assessment instrument ratings, experience inventory ratings, motivational fit inventory ratings, and multi-rater evaluations ratings.

15. The system of claim 9, wherein each of the one or more competencies comprises three or more associated behaviors.

16. The system of claim 15, wherein at least one behavior is shared by a plurality of competency ratings.

17. A method of providing an automated assessment center, the method comprising:
determining, by a processing device, the one or more competencies to assess for the assessment participant
determining, by the processing device, the plurality of associated behaviors for each of the one or more competencies to assess;
providing, by the processing device, one or more assessments to an assessment participant, wherein the one or more assessments comprise tasks designed to express each of a plurality of behaviors associated with one or more competencies to be assessed as demonstrated by the assessment participant when completing the one or more assessments;
receiving, by the processing device, a plurality of behavior ratings from a plurality of assessors, wherein each behavior rating comprises a rating for an associated behavior as demonstrated by the assessment participant when completing the one or more assessments;
determining, by the processing device, an initial competency rating for each of the one or more competencies to assess based upon the plurality of behavior ratings;
for each competency, combining, by the processing device, the initial competency rating with one or more non-simulation assessment results;
determining, by the processing device, a final competency rating for each of the one or more competencies to assess based upon the combined initial competency rating and the at least one non-simulation assessment result; and
generating, by the processing device, a report including at least the final competency rating for each of the one or more competencies to assess, wherein the report further includes a listing of one or more topic for a feedback discussion between the assessment participant and an assessment administrator.

18. (canceled)

19. The method of claim 17, further comprising aggregating, by the processing device, at least a portion of the plurality of behavior ratings based upon an associated simulation.

20. The method of claim 19, further comprising aggregating, by the processing device, the plurality of behavior ratings based upon an associated competency.
